(19) United States
(12) Patent Application Publication
(10) Pub. No.: US 2014/0274403 A1
(43) Pub. Date: Sep. 18, 2014

(54) Systems and Methods for Identifying Virtual Entities in a Virtual Environment

(71) Applicant: AGINCOURT GAMING LLC, Allen, TX (US)

(72) Inventor: Nikolaos Anastasopoulos, Athens (GR)

(73) Assignee: AGINCOURT GAMING LLC, Allen, TX (US)

(21) Appl. No.: 13/828,825

(22) Filed: Mar. 14, 2013

(51) Int. Cl. A63F 13/12

(52) U.S. Cl. CPC A63F 13/12
USPC 463/42

(57) ABSTRACT

Disclosed herein are systems and related methods for providing a gaming environment where users of a network system can be connected with each other, and by using predefined player virtual entities, or by creating new ones, they can play against each other, or against an artificial intelligence (AI) opponent alone or in a cooperative mode. The disclosed principles provide various options to users, and depending on a user's choice and/or the specifications of his virtual gaming entity, a system or process in accordance with the disclosed principles provides a very fast and efficient matchmaking process for identifying other virtual entities and/or users for gameplay with the searching user. This corresponds to a pleasing gaming experience for all the users participating in a virtual gaming environment, and provides a fair chance to all users to complete given goals within the gaming environment.

### TECHNICAL FIELD

The present disclosure relates generally to local or online environments, to which users connect and interact with the environment alone or with other users either cooperatively or competitively, and more specifically to a technique for locating matching virtual entities and/or their users for gameplay in the virtual environment.

### BACKGROUND

It is well known that the Internet has transformed our world, and currently long distances between people and locations are considered almost nonexistent when it comes to the receiving and sending of information. The entire world has been transformed into a virtually smaller place where people from all over the world can access information and communicate with other people instantly, without any regard of the distance. It is only logical to say that the Internet is providing a common space for users from all over the world to connect and interact with each other.

In addition to the exchange of information between users, technology has also made the creation of gaming environments into virtual environments where users can entertain themselves. Over the past few years, multiplayer games have become very famous and are enjoyed by millions of people worldwide. As social interaction in multiplayer games is very important, the need of a mechanism that, under a set of rules and specifications, brings together users who know each other, and, perhaps more importantly, those who are not familiar with each other. This is especially the case when competition is an element of the gaming environment, and unfairness could create a bad gaming experience.

In a fast-paced world where time is precious and information travels at the speed of light, users do not expect delays when it comes to entertainment in a multiplayer environment. Those users want to instantly be able to play with their friends or even against their friends, but they also want the ability to play against other users from anywhere in the world when desired. All of the above are a series of challenges for which today's game providers are called on to face and provide solutions. More specifically, in multiplayer games, success at meeting these challenges could mean the success or the failure of a product. Accordingly, what is needed in the art are systems and methods for facilitating users to participate in online, multiplayer environments with friends or strangers, or even against an artificial intelligence opponent, but in a fair and substantially equally competitive manner.

### SUMMARY

This summary is provided to describe certain aspects of embodiments of the invention. It is not intended to show the essential features of the invention nor is it intended to limit the scope of the claims.

Disclosed herein are systems and related methods for providing a gaming environment where users of a network system can be connected with each other. By using predefined player virtual entities, or by creating new ones, they can play against each other, or against an artificial intelligence (AI) opponent alone or in a cooperative mode. The disclosed principles provide various options to users, and depending on a user's choice and the specifications of his gaming entity, a system or process in accordance with the disclosed principles follows certain rules and specifications to provide a very fast and efficient service of the user's matching request. This corresponds to a pleasing gaming experience for all the users participating in a virtual environment, and provides a fair chance to all users to complete given goals within the gaming environment.

In one embodiment, the disclosed principles may be implemented and operated locally from the user's side. In another embodiment, the disclosed principles may be implemented and operated remotely in a different server, where the gaming environment could also be generated. In another embodiment, the disclosed principles may be implemented and operated remotely in a server and the gaming environment is created and downloaded by the user. In another embodiment, the disclosed principles may be implemented and operated remotely in a first server and the gaming environment of the user is created in a second, different server, where the user's system is then redirected to access the environment.

In one implementation, a method of identifying virtual entities for competitive or cooperative gameplay in a virtual gaming environment may comprise establishing a virtual entity for use by a first user in a virtual environment, and placing the virtual entity in a lobby associated with the virtual environment. Such an exemplary method may or may not further comprise receiving a selection of a gameplay mode from the first user. Such a method may also include initiating a matchmaking search to identify other virtual entities controlled by other users by determining if one or more characteristics of the first user and/or the first user's virtual entity respectively matches one or more characteristics of the other virtual entities and/or the other users. When no matching virtual entities are identified, exemplary methods may include reducing a threshold for determining if one or more characteristics of the first user and/or the first user's virtual entity respectively matches one or more characteristics of the other virtual entities and/or the other users. Stated another way, reducing a threshold may be an increase in the acceptable differences between entities and/or users. Such methods may continue reducing the threshold a predetermined number of times, where each reduction increases the likelihood of identifying of one or more matching virtual entities. If no matching virtual entities are identified after reducing the threshold the predetermined number of times, an exemplary method may then present the first user a choice of an alternative gameplay mode. However, if one or more matching virtual entities are identified, exemplary methods may then include receiving a selection by the first user of one or more of the identified matching virtual entities, and possibly requesting acceptance of an invitation to the users of the identified one or more matching virtual entities to participate in a game with the first user in the virtual environment. Such methods may further comprise initiating gameplay in the virtual environment with the first user's virtual entity and accepting ones of the one or more of the selected matching virtual entities.

In another aspect, computer systems providing a virtual gaming environment for competitive or cooperative gameplay of virtual entities are also disclosed. In exemplary embodiments, such a system may comprise a server device and associated software for hosting a virtual gaming environment, and a data storage for storing virtual entities for use by a corresponding users in the virtual environment. Such a system may also comprise a computing device and associated software associated with the server device and data storage for providing a virtual lobby associated with the virtual environment, wherein a first user's virtual entity is placed in the lobby prior to gameplay in the virtual environment. Additionally, such embodiments may comprise an engine associated with the computing device and configured to conduct a matchmaking search to identify other virtual entities controlled by other users by determining if one or more characteristics of the first user and/or the first user's virtual entity respectively matches one or more characteristics of the other virtual entities and/or the other users. In such embodiments, the engine may be configured to reduce, when no matching virtual entities are identified, a threshold for determining if one or more characteristics of the first user and/or the first user's virtual entity respectively matches one or more characteristics of the other virtual entities and/or the other users. Such an engine may also be configured to continue reducing the threshold a predetermined number of times, wherein each reduction increases the likelihood of identifying one or more matching virtual entities, and if one or more matching virtual entities are identified, receive a selection by the first user of one or more of the identified matching virtual entities. Furthermore, in exemplary systems according to the disclosed principles, the server device may also then be configured to initiate gameplay in the virtual environment with the first user's virtual entity and one or more of the selected matching virtual entities.

### BRIEF DESCRIPTION OF THE DRAWINGS

Embodiments are illustrated by way of example in the accompanying figures, in which like reference numbers indicate similar parts, and in which:

FIG. 1 illustrates a flow diagram setting forth one embodiment of a user's request to participate in a gaming environment, in accordance with the disclosed principles;

FIG. 2 illustrates a flow diagram demonstrating the logic behind the servicing of a user requesting a competitive gameplay mode against one or more other users, in accordance with the disclosed principles;

FIG. 3 illustrates a flow diagram setting forth an exemplary process for the reduction of a threshold used for the disclosed matchmaking process, in accordance with the disclosed principles;

FIG. 4 illustrates a flow diagram for an exemplary process followed when a user wishes to interact with against the AI of a virtual environment either alone or in a cooperative mode with other users, in accordance with the disclosed principles;

FIG. 5 illustrates a block diagram demonstrating the logic behind the process of determining the weight given to certain information regarding the user's VE and used in comparisons and/or calculations during the matchmaking search process, in accordance with the disclosed principles;

FIG. 6 illustrates a flow diagram setting forth an exemplary process of using the weight values assigned to a plurality of VEs for determining possible matches in accordance with the disclosed principles; and

FIG. 7 illustrates a flow diagram showing one embodiment of the logic behind a system trigger implemented in accordance with the disclosed principles.

### DETAILED DESCRIPTION

Looking initially at FIG. 1, illustrated is a flow diagram 100 setting forth one embodiment of a user's request to participate in a gaming environment, in accordance with the disclosed principles. At a start step 105, the user initiates a connection to a gaming environment. The user can be either connected to a gaming environment that is operating locally, or to a gaming environment that is operating online. At step 110, after connection to the gaming environment, the user may login with his account information, or create an account if one does not already exist. Upon logging into the gaming environment, the user may use a predefined virtual entity (hereafter called “VE”) provided by the gaming environment or create a new one, with which he will interact with the virtual environment and other VEs controlled by other users. In another embodiment, the user may create a new VE right before the gameplay is initiated, or simply use a VE the user has previously created in the same gaming environment. In yet other embodiments, users may login through other means, for example, through a Facebook® or other similar account.

At step 115, the user may select the type of gameplay desired. In one embodiment, the user may select a competitive mode at step 120, where a user or a number of users controlling VEs will play against each other in a predetermined virtual environment. If the user selects this gameplay mode, the process then continues with reference to FIG. 2.

In another embodiment, the user may select that he or she, and possibly other users, plays against the AI of the gameplay environment at step 125. In one such embodiment, a system or process in accordance with the disclosed principles may provide a single player mode, show at step 130, where the user is the only human player controlling a VE and interacting with the virtual environment. Alternatively, a system or process in accordance with the disclosed principles may provide a cooperative mode, shown at step 135, where multiple users controlling VEs are cooperating together to achieve common goals, while interacting with a predetermined virtual environment. If the user selects a gameplay mode against the environment AI, the process continues with reference to FIG. 4.

Turning to FIG. 2, illustrated is a flow diagram 200 demonstrating the logic behind the servicing of a user requesting a competitive gameplay mode against one or more other users, as selected at step 120. Next, the user will prepare a VE for gameplay at step 205. In one embodiment, the user may have a stored VE that he will load for use in the gaming environment. In another embodiment, the user may use a VE predefined by the gaming environment with which he will interact with the virtual environment and other VEs. In yet another embodiment, the user will instead create a VE which he may or may not customize. Upon loading or finalizing the VE, the system will store the VE's information, which may be used afterwards for the creation and specifications of the virtual environment, as well as the matchmaking process disclosed herein.

After the VE information is stored, the user, via his VE, enters a “Lobby” area at step 215. In the Lobby, a system or process in accordance with the disclosed principles provides a matchmaking feature with respect to the user's VE, as described in greater detail below. More specifically, because the user has previously selected a user(s) vs. user(s) gameplay mode at step 120, the user desires to find one or more VEs having information/data that “matches” the information of his own VE. The search for a “matching” VE within a system or process in accordance with the disclosed principles may be based on a number of various factors. For example, the information used to find a matching VE may encompass characteristics of the user's VE. In such embodiments, characteristics may include factors such as skill level or other features of the VE establishing its capabilities within a given gaming environment. Such searches may be for VEs having the same or similar factors related to VE capability, or alternatively for VEs having lower or greater capabilities as compared to the searching user's VE. Alternatively or additionally, matching characteristics may be based on information of the user rather than direct data about the VE. For example, the user may search to be matched with VE(s) controlled by users that are related to the user, or perhaps designated as “friends” of the user. Also, searches may be made for VEs with which the user's VE has previously played in a game.

After the user selects the information by which he seeks to find one or more matching VE, the matchmaking process, at step 220, determines if there are any potentially matching VEs, identified in accordance with the user's search criteria, and such potential matches are shown in the Lobby for the user's review. When a matchmaking search is made, if one or more satisfactory matches is found in the Lobby, the user would be able select the matching VE(s) he desires to play. Alternatively, the system may make the selection for the user. In such embodiments, the system or process may compare weight values of the VEs (which is discussed in detail with reference to FIG. 5), and use a series of rules to complete the matchmaking (which is discussed in detail with reference to FIG. 6). Among the determination of possible matches, the disclosed system or process may also compare the information of the various VEs in the Lobby in an effort to create valid opposing teams for a fair but competitive gaming experience.

Additionally, in this user(s) vs. user(s) gameplay scenario, other users' VEs may already be present in the Lobby. These VEs may or may not be potential matches for the user's search criteria, and may instead also be waiting in the Lobby for other users to participate with them in a user(s) vs. user(s) gameplay mode. Accordingly, in some embodiments, the search criteria of the user may simply be a search for other users looking to participate in a user(s) vs. user(s) game. If no potential matches have been found, or if the Lobby is empty of other users' VEs in general, and thus the Lobby is empty, the process moves to step 225 where the user may wait until a matching VE(s) or other users' VEs are displayed in the Lobby. More specifically, the system or process may or may not inform the user about the current situation and request him to either wait longer or cancel the selected gameplay mode, in which case the process would return back to the process illustrated in FIG. 1. A system trigger, which can be, but is not limited to, a timer, event, player action, system action, etc. may operate as discussed below with respect to FIG. 7 if the Lobby is empty and the user's VE continues to wait in the Lobby. In other embodiments, the system or process may cancel the user's request for the specific gameplay mode automatically. Additionally, the time at this point in the matching process may be stored.

If it is determined that matched VEs are now in the Lobby, either based on the user's search criteria or because other users' VEs are present in the Lobby looking for a user(s) vs. user(s) game, the process, at step 230, compares information regarding the user's VE to the information regarding the other VEs in the Lobby. The results of the comparison of VEs in the matchmaking Lobby may be displayed to the user, if desired. Among the matchmaking search results, the user may be presented with the possible matches for his matchmaking search. In other embodiments, he may not be presented with possible matches, and instead gameplay may be initiated with the one or more matched entities/users. At step 235 it is determined if there are any potential matches for the user, again either based on his search criteria or because other users are simply looking for a user(s) vs. user(s) game. If no satisfactory match is found, the process moves to step 240, where the attempt number of the matchmaking search is stored. At this point, the process would move to FIG. 3, as discussed in detail below.

In the case of a successful matchmaking, then a system or process in accordance with the disclosed principles informs the user about the possible matching VEs at step 245. In such embodiments, the user may not be informed of the matching VEs, and instead user(s) vs. user(s) gameplay is simply initiated with the match(es). Once user VEs are selected via the matchmaking process discussed herein, the users controlling the matched VEs may be requested to accept the matched user(s) vs. user(s) game, and upon acceptance, the users are requesting initiation of service for the game. At step 250, it is determined if all of the matched users accept. If all the users participating in the matched user(s) vs. user(s) game accept the match(es), then the gameplay service starts at step 255. In such embodiments, the gameplay system initiates the service immediately and the VEs are redirected into the virtual environment to begin their interaction. However, if at least one of the users included in the successful matchmaking declines or does not accept within a specific time limit, then all accepting users may be so informed at step 260. If this occurs, all remaining VEs in the unsuccessful matchmaking may be returned to the Lobby, where the matchmaking process may start again.

Turning now to FIG. 3, illustrated is a flow diagram setting forth an exemplary process for the reduction of a threshold used for the disclosed matchmaking process. The process continues the logic flow from step 240 of FIG. 2, where the matchmaking attempt number (hereinafter “MAN”) was stored when a proper match(es) was not found. At step 305, it is determined whether the MAN exceeds a predetermined limit of matchmaking attempts. If the MAN does not surpass a predetermined limit of attempts, then the matchmaking process returns to step 220 in FIG. 2, where additional attempts at matchmaking may take place.

If, however, it is determined at step 305 that the MAN surpasses the predetermined number of attempts, then the system or process reduces the threshold search criteria requirements for the matchmaking process at step 310. Specifically, when the threshold requirements of the search criteria selected by the searching user, or employed by the system itself, are reduced, the rules for determining VEs that match the matchmaking search criteria are modified. For example, if the original matchmaking search sought VEs having the same skill or experience level with respect to a specific game as the user's VE, and no matching VEs were found, the threshold for comparing the skill or experience level of other VEs may be modified to find VEs that fall within a close, rather than exact, match to the skill or experience level of the user's VE. Thus, the rules for determining a match based on skill or experience level would be modified to locate such close matches. In this example, if an exact match for an exemplary skill level of 7 out of 10 is not found, the threshold may be modified to search for matches that fall within 1 skill level point, thus VEs of skill level 6 and 8. Alternatively, using the same example, if an exact match cannot be found, perhaps the threshold can be altered to find close matches, but only of lesser or equal skill level, thus finding VEs of skill level 6 but not 8.

Also, in some embodiments, the reduction of the threshold requirements can be predetermined by a given set of rules. In other embodiments, the reduction of the threshold requirements can be modified according to various sets of rules dependent on specific elements of the matchmaking search criteria. For example, one set of rules for reducing the threshold requirements may be used based on specific VE characteristics searched by the original user, while another set of rules may be used based on the status of the Lobby or some other status or information related to the matchmaking search. In a specific example, assume the matchmaking process is attempting to match two or more users, each having an army with a given number of Army Points (APs). When the matchmaking process cannot initially find a match between two or more players, for example, for a player vs. player battle, then every X seconds the process may change the army of a lower level player found in the matching attempt by adding 1 unit of a given weight value to the lower level player's army. Then the matchmaking algorithm may be run again in an attempt to match the original user with another player. Whatever the added unit is, the result is that the AP value of the lower level player's army is increased, so as to be more likely to match the APs of the original user searching for a match to play against. If the addition (i.e., reduction in threshold to finding a match) to the initially non-matching player's army is sufficient to match the searching user, then the matching process is completed. If, however, the addition is insufficient to create a match, then the process may add 1 more weighting unit to the lower level player's army (i.e., further reducing the threshold requirement for matching the original user's army), and the matching algorithm runs again. This could continue to a certain limit of added weight units. In sum, any rules may be used in accordance with the disclosed principles to determine the means by which the threshold requirements are reduced, and likewise any portion of the threshold requirement(s) may be modified (and perhaps other portions not) depending on the applicable rules.

Continuing with the process of FIG. 3, at step 315, any VEs that may be present in the Lobby with the original user's VE may be compared using the newly reduced search threshold requirements. Alternatively or additionally, the matchmaking search can again be conducted in accordance with the exemplary process of FIG. 2. At step 320, it is determined if the new attempt at matchmaking was successful. If the new matchmaking process is successful, then the remainder of the process is completed as shown in FIG. 2. However, if the new matchmaking process using the reduced threshold is also not successful, then the process would move to step 325 where the attempt number of the matchmaking search is stored.

At step 330, it is determined if the attempt number for the retried matchmaking search has surpassed a predetermined number of retry attempts. If the number of retried matchmaking searches has not exceeded the attempt limit, then the process returns to step 310 where the threshold search requirements may be further reduced. Such reduction would typically then occur in the manner discussed above; however, alternative threshold reduction techniques may also be employed. If, at step 330, it is determined that the retry attempt number for searches has exceeded the maximum limit of retries, then the system or process may present an alternate service to the user, as shown in step 335. For example, if the user had been searching for a match to play in a user(s) vs. user(s) game, and no matches had been found within the allotted number of retry attempts, then the system or process may present the user the option to switch to a user vs. AI mode of gameplay.

At step 340, the user may be requested to accept the alternative service, and if the user accepts the alternative service, then that service would start for the user, as shown in step 345. If the user does not accept the alternative service, then the matchmaking attempt number (MAN) may be changed as shown in step 350. In one embodiment, the MAN may be reset to zero, and the user then may or may not be returned to the matchmaking Lobby, as shown in step 355. However, in other embodiments, if the user did not accept the alternative service, the process may simply return the user to step 310, where the threshold is again reduced and the matchmaking attempts continued as discussed above. In still other embodiments, the system or process may simply cancel the user's gameplay mode automatically when the user does not accept the alternative service. The user can then, on his own, return to the matchmaking Lobby to begin the matchmaking process from the beginning, perhaps including different search criteria.

Looking now at FIG. 4, illustrated is a flow diagram 400 for an exemplary process followed when a user wishes to interact with the AI of a virtual environment either alone or in a cooperative mode with other users. Specifically, this exemplary process continues from FIG. 1, when the user selected a user(s) vs. AI gameplay mode. At a step 405, it is determined if the user selected single player mode or cooperative mode, where the user would team up with other human users against the AI of the gaming environment. As mentioned above, the user may use a previously established VE, or create a new VE before beginning gameplay, or if applicable, the matchmaking process.

If the user selects single player mode, a system or process in accordance with the disclosed principles may follow a predetermined set(s) of rules which will determine the creation of the virtual environment in which the user's VE will interact against the AI. Additionally, at step 410 the user may be presented with a series of different options which may define characteristics of the gaming experience, such as, but not limited to, level of difficulty, virtual environment creation, types of AI entities, etc. At a step 415, the user's VE is prepared for gameplay. In some embodiments, the system or process may offer a series of different options to the user regarding his VE. Alternatively, the user may elect to create a new VE for the gameplay session as mentioned above. After the user makes his VE selection(s), the VE's information may be stored for use in the virtual environment at step 420. Once the user makes all the available choice(s), his choices are stored and the system, at step 425, determines and renders the virtual environment with which the user's VE will interact. At step 430, gameplay is initiated in the rendered virtual environment.

If it was determined at step 405 that the user selected cooperative gameplay mode, the illustrated process moves to step 435 where the user's VE is prepared for gameplay. As before, the user may be presented with a series of different options which may define characteristics of the gaming experience, such as, but not limited to, level of difficulty, virtual environment creation, types of AI entities, etc. After the user makes his VE selection(s), the VE's information may be stored for use in the virtual environment at step 440. Once the user makes all the available choice(s), the user's VE can enter the matchmaking Lobby for a matching search in the manner described in detail above.

At step 450, it is determined if the Lobby is empty, or if other VEs, perhaps also seeking a cooperative gameplay experience, are present in the Lobby. If the Lobby is found to be empty, then in one embodiment the current time is stored and the process may move to step 455 where the user's VE may wait until another VE enters the Lobby. A system trigger, which can be, but is not limited to, a timer, event, player action, system action, etc. may then operate, as shown in FIG. 7. Alternatively, if the Lobby is found to be empty at step 450, the user may search for matches while in the Lobby using his desired search criteria in order to add potential matching VEs to the Lobby. Specifically, the matchmaking search may proceed in the manner discussed above with reference to FIG. 3.

At step 460, if the user is simply waiting for other VEs to enter the Lobby rather than running a matchmaking search, it is determined if the time the user has been waiting for another VE to enter the Lobby has exceed a predetermined limit. If that time limit has not been exceeded, then the user's VE may remain in the Lobby waiting for another VE to enter. If the time limit has been exceeded, the process may move to step 465 where the user may be presented the option to switch to an alternative service, such as a different mode of gameplay. At step 470, the user may be requested to accept the alternative service, and if the user accepts the alternative service, then that service would start for the user, as shown in step 475. If the user does not accept the alternative service, the user may be returned to the matchmaking Lobby for additional waiting. Alternatively, if the user does not accept the alternative service, then the user may be returned to the Lobby and the matchmaking process continued as discussed above, where the threshold for matching the user's search criteria may be reduced. If additional matchmaking attempts are to be made by the user, the threshold may again be reduced and the matchmaking attempts continued as discussed above. In still other embodiments, the system or process may simply cancel the user's gameplay mode automatically when the user does not accept the alternative service. The user can then, on his own, return to the matchmaking Lobby to begin the matchmaking process from the beginning, perhaps including different search criteria.

If at step 450 it was determined that the Lobby is not empty, either because other VEs were already waiting in the Lobby or matching VEs were found with the matchmaking process, then the disclosed system or process may compare stored information of each VE in the Lobby, including the original user's VE, at step 480. Additionally, if desired, the process at step 485 may use a set(s) of rules to create a new virtual entity or entities from the VEs waiting in the Lobby or newly arrived in the Lobby. At step 490, the process may then use all of the information regarding the user's VE and any waiting or newly created VEs in the Lobby to create the virtual environment with which the VEs will interact cooperatively during gameplay. Once the VEs are selected/created and the virtual environment rendered, gameplay may be initiated as shown in step 430.

FIG. 5 illustrates a block diagram 500 demonstrating the logic behind the process of determining the weight given to certain information regarding the user's VE and used in comparisons and/or calculations during the matchmaking search process. At step 505, a system or process in accordance with the disclosed principles collects a given amount of information (510A-510E) of a VE/user to be used for calculations, comparisons, etc. in the matchmaking process.

After the information is collected, the process at step 515 then assigns a weight value to each information value according to specified rules of an algorithm. The importance of a number given to a piece of information can be defined and given a specific weight in determining the final weight value of the VE/user. More specifically, a specific set(s) of rules is used at step 520 to calculate the weight values to be given each piece of information considered during the matchmaking process. The importance/weight of an information value can vary depending on the rules employed, which creates a highly dynamic calculation of the final weight(s) of a VE/user. This provides a very accurate weighting process for the determination of a status and/or calculation of an outcome during the disclosed matchmaking process.

At step 525, the calculated weights/values assigned to the various pieces of information, which defines the overall matchmaking search criteria, are then employed in an algorithm to identify possible matches. At step 530, the possible matches identified by the disclosed matchmaking process may be presented to the searching user, for example, in the matchmaking Lobby. The user may then select one or more matching VEs for the preselected gameplay mode, and the users of those matching VEs may then be presented with the option of agreeing to join the original user in the selected gameplay mode.

Turning now to FIG. 6, illustrated is a flow diagram 600 setting forth an exemplary process of using the weight values assigned to a plurality of VEs for determining possible matches in accordance with the disclosed principles, for example, using the weighting/calculation process discussed with the respect to FIG. 5. Specifically, a number of matching VEs (605A-605F) from a matchmaking process conducted by a user for a user(s) vs. user(s) gameplay mode may be placed in the Lobby with the searching user's VE.

At step 610, a matchmaking system or process in accordance with the disclosed principles may furthermore propose opposing teams for use in the selected user(s) vs. user(s) gaming environment. More specifically, based on the search criteria used for the matchmaking process, the system or process may employ the collected/calculated weight values of each of the matching VEs to propose opposing teams using a given set(s) of rules. In an exemplary embodiment, the system or process may or may not try to include as many matching VEs in the composition of the teams, perhaps in order to service as many users as possible in the shortest possible time. At step 615, if the system or process is successful at establishing opposing teams in accordance with the matchmaking process, then the process may continue at step 245 of FIG. 2, where the users of the matched VEs may be requested to accept the proposed team assignments and thus initiate gameplay in the user(s) vs. user(s) mode.

If the attempt to create opposing teams from the matched VEs is not successful at step 615, for example, because not enough matching VEs have been located or the weight values of each matched VE does not allow for fairly matched opposing teams, the process may move to step 620 where the rules for creating the teams may be changed. More specifically, as with the original matchmaking process discussed above to identify possible matching VEs, the rules for determining opposing teams may be loosened in order to arrive at the desired opposing teams. Once the tolerance of the rules for establishing the teams have been loosened, the process may again attempt to create the two or more opposing teams from the matched VEs.

At step 625, if it is determined that the new attempt to create teams is successful, then the process may conclude at step 245 as discussed above. However, if it is determined that the new attempt to create teams is unsuccessful at step 625, then the process may move to step 630, where it is determined if the retry attempt to create matched opposing teams has exceeded a predetermined number of attempts. If the number of the attempt is valid, i.e., has not exceed the predetermined limit, the process may move back to step 620, where the set of rules for creating matched opposing teams may again be changed (e.g., loosened) and the creation process attempted again. However, if the retry attempt at creating opposing teams has exceeded the predetermined limit, then the process may proceed to step 335 of FIG. 3 where the searching user may be presented with an alternative service than the selected user(s) vs. user(s) gameplay mode. Alternatively, the original user may simply be returned to the Lobby where he may conduct a new matchmaking process in the originally selected user(s) vs. user(s) gameplay mode.

Turning finally to FIG. 7, illustrated is a flow diagram showing one embodiment of the logic behind a system trigger implemented in accordance with the disclosed principles, such as the exemplary system trigger(s) discussed above. As mentioned above, a system trigger can be, but is not limited to, a timer, event, player action, system action, etc., and activates a specific event/action in the system or process implemented in accordance with the disclosed principles. Such an event/action can be a time check, which could be initiated in the matchmaking Lobby and may be employed for all VEs present in the Lobby.

In the illustrated embodiment, the exemplary system trigger is a time check, established at a start step 705. Such a time check could be used to determine whether the waiting time of a VE in the Lobby is more or less than a predetermined value. Thus, at step 710, a “hit” or check is made of the Lobby to determine the time any VEs in question have been waiting in the Lobby, for example, waiting for another VE to enter the Lobby or for VEs matching a search to be identified. At step 715, it is determined if the wait time of a particular VE is under or exceeds a predetermined limit. If the time check of a VE in question has exceeded a certain limit, then at step 720 the system may or may not provide an alternative service to the user of the VE in question, similar to the alternative service presentment and/or acceptance discussed above with respect to FIGS. 3 and 4. If the time check of a VE in question is under the predetermined limit, then at step 715 the VE in question may simply be left continuing to wait in the Lobby until another VE enters the Lobby and the current time stored for future reference.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A method of identifying virtual entities for competitive or cooperative gameplay in a virtual gaming environment, the method comprising:
establishing a virtual entity for use by a first user in a virtual environment;
placing the virtual entity in a virtual lobby associated with the virtual environment;
initiating a matchmaking search to identify other virtual entities controlled by other users by determining if one or more characteristics of the first user or the first user's virtual entity respectively matches one or more characteristics of the other virtual entities or the other users;
when no matching virtual entities are identified, reducing a threshold for determining if one or more characteristics of the first user or the first user's virtual entity respectively matches one or more characteristics of the other virtual entities or the other users;
continuing the reducing of the threshold a predetermined number of times, each reduction increasing the likelihood of identifying of one or more matching virtual entities;
if one or more matching virtual entities are identified, receiving a selection by the first user of one or more of the identified matching virtual entities; and
initiating gameplay in the virtual environment with the first user's virtual entity and one or more of the selected matching virtual entities.

2. A method according to claim 1, wherein continuing the reducing of the threshold comprises reducing the threshold only a predetermined number of times, and thereafter terminating the matchmaking search.

3. A method according to claim 2, further comprising, upon terminating the matchmaking search, presenting the first user a choice of an alternative gameplay mode.

4. A method according to claim 2, further comprising, upon terminating the matchmaking search, allowing the first user's virtual entity to wait in the lobby for any other virtual entities matching the one or more characteristics of the first user or the first user's virtual entity to enter lobby.

5. A method according to claim 1, further comprising requesting acceptance of the gameplay by the users of the identified one or more matching virtual entities before initiating the gameplay in the virtual environment.

6. A method according to claim 1, further comprising establishing one or more parameters of the virtual environment based on the matching one or more characteristics.

7. A method according to claim 1, wherein the one or more characteristics include skill level of the first user, age of the first user, relationship of the first user with other users, skill level of the first user's virtual entity, experience rating of the first user's virtual entity, or strength rating of the first user's virtual entity.

8. A method according to claim 1, wherein initiating a matchmaking search comprises assigning values to each of the one or more characteristics, and employing a weighing algorithm to determine matches.

9. A method according to claim 1, further comprising receiving a selection of a gameplay mode from the first user prior to initiating the matchmaking search.

10. A method according to claim 9, wherein the gameplay mode is user(s) versus user(s) mode or user(s) versus artificial intelligence of the gaming environment.

11. A method according to claim 1, wherein if a plurality of matching virtual entities are identified, establishing two or more opposing teams comprising the first virtual entity and the plurality of match virtual entities based on the one or more matching characteristics.

12. A method of identifying virtual entities for competitive or cooperative gameplay in a virtual gaming environment, the method comprising:
establishing a virtual entity for use by a first user in a virtual environment;
placing the virtual entity in a lobby associated with the virtual environment;
receiving a selection of a gameplay mode from the first user;
initiating a matchmaking search to identify other virtual entities controlled by other users by determining if one or more characteristics of the first user or the first user's virtual entity respectively matches one or more characteristics of the other virtual entities or the other users;
when no matching virtual entities are identified, reducing a threshold for determining if one or more characteristics of the first user or the first user's virtual entity respectively matches one or more characteristics of the other virtual entities or the other users;
continuing the reducing of the threshold a predetermined number of times, each reduction increasing the likelihood of identifying of one or more matching virtual entities;
if no matching virtual entities are identified after reducing the threshold the predetermined number of times, presenting the first user a choice of an alternative gameplay mode;
if one or more matching virtual entities are identified, receiving a selection by the first user of one or more of the identified matching virtual entities;
requesting acceptance of an invitation to the users of the identified one or more matching virtual entities to participate in a game with the first user in the virtual environment; and
initiating gameplay in the virtual environment with the first user's virtual entity and accepting ones of the one or more of the selected matching virtual entities.

13. A method according to claim 12, further comprising if no matching virtual entities are identified after reducing the threshold the predetermined number of times, terminating the matchmaking search and allowing the first user's virtual entity to wait in the lobby for any other virtual entities matching the one or more characteristics of the first user or the first user's virtual entity to enter lobby.

14. A method according to claim 12, further comprising establishing one or more parameters of the virtual environment based on the matching one or more characteristics.

15. A method according to claim 12, wherein the one or more characteristics include skill level of the first user, age of the first user, relationship of the first user with other users, skill level of the first user's virtual entity, experience rating of the first user's virtual entity, or strength rating of the first user's virtual entity.

16. A method according to claim 12, wherein initiating a matchmaking search comprises assigning values to each of the one or more characteristics, and employing a weighing algorithm to determine matches.

17. A method according to claim 12, wherein the gameplay mode is user(s) versus user(s) mode or user(s) versus artificial intelligence of the gaming environment.

18. A method according to claim 12, wherein if a plurality of matching virtual entities are identified, establishing two or more opposing teams comprising the first virtual entity and the plurality of match virtual entities based on the one or more matching characteristics.

19. A computer system providing a virtual gaming environment for competitive or cooperative gameplay of virtual entities, the system comprising:
a server device and associated software for hosting a virtual gaming environment;
a data storage for storing virtual entities for use by corresponding users in the virtual environment;
a computing device and associated software associated with the server device and data storage for providing a virtual lobby associated with the virtual environment, a first user's virtual entity placed in the lobby prior to gameplay in the virtual environment;
an engine associated with the computing device and configured to conduct a matchmaking search to identify other virtual entities controlled by other users by determining if one or more characteristics of the first user or the first user's virtual entity respectively matches one or more characteristics of the other virtual entities or the other users;
wherein the engine is further configured to:
reduce, when no matching virtual entities are identified, a threshold for determining if one or more characteristics of the first user or the first user's virtual entity respectively matches one or more characteristics of the other virtual entities or the other users,
continue reducing the threshold a predetermined number of times, wherein each reduction increases the likelihood of identifying one or more matching virtual entities, and
if one or more matching virtual entities are identified, receive a selection by the first user of one or more of the identified matching virtual entities; and
wherein the server device is configured to initiate gameplay in the virtual environment with the first user's virtual entity and one or more of the selected matching virtual entities.

20. A system according to claim 19, wherein the computing device is further configured to request acceptance of the gameplay by the users of the identified one or more matching virtual entities before gameplay in the virtual environment is initiated.

21. A system according to claim 19, wherein the computing device is further configured to establish one or more parameters of the virtual environment based on the matching one or more characteristics.

22. A system according to claim 19, wherein the one or more characteristics include skill level of the first user, age of the first user, relationship of the first user with other users, skill level of the first user's virtual entity, experience rating of the first user's virtual entity, or strength rating of the first user's virtual entity.

23. A system according to claim 19, wherein the engine configured to conduct a matchmaking search comprises assigning values to each of the one or more characteristics, and employing a weighing algorithm to determine matches.

24. A system according to claim 19, wherein the computing device is further configured to receive a selection of a gameplay mode from the first user prior to initiating the matchmaking search.

25. A system according to claim 24, wherein the gameplay mode is user(s) versus user(s) mode or user(s) versus artificial intelligence of the gaming environment.

26. A system to claim 24, wherein the engine is further configured to, when no matching virtual entities are identified after reducing the threshold the predetermined number of times, present the first user a choice of an alternative gameplay mode.

27. A system according to claim 19, wherein if a plurality of matching virtual entities are identified, the computing device is further configured to establish two or more opposing teams comprising the first virtual entity and the plurality of match virtual entities based on the one or more matching characteristics.
